(19) United States
(12) Patent Application Publication
(10) Pub. No.: US 2015/0358745 A1
(43) Pub. Date: Dec. 10, 2015

(54) SELF ADMINISTERED CALIBRATED HEARING KIT, SYSTEM AND METHOD OF TESTING

(71) Applicant: RIX DESIGN, Hershey, PA (US)

(72) Inventors: Robert D. RIX, Hershey, PA (US); Mohammad Siddique AHMED, Mechanicsburg, PA (US); James SHAFER, York, PA (US)

(21) Appl. No.: 14/297,828

(22) Filed: Jun. 6, 2014

(51) Int. Cl. H04R 25/00

(52) U.S. Cl. CPC H04R 25/305

(57) ABSTRACT

An earpiece for use in conducting a hearing test, a hearing test kit and a method of conducting a hearing test. The earpiece includes a speaker which generates stimuli and a microphone which detects ambient noise. The stimuli generated by the speaker compensates for the ambient noise detected by the microphone. The method including: detecting ambient noise using a microphone housed in an earpiece; analyzing the ambient noise; and generating stimuli which have been adjusted to compensate for the ambient noise through a speaker housed in the earpiece.

### FIELD OF THE INVENTION

The present invention is directed to a kit, a system and a method for a self calibrated hearing test. In particular, the invention is directed to a kit, system and method utilizing web based delivery, onboard software and electronics embedded in a headset.

### BACKGROUND OF THE INVENTION

Testing of hearing sensitivity is usually performed by an audiologist using an audiometer to present a series of pure tone (Pure Tone Air Conduction Test) stimuli to a test subject at controlled frequencies and intensities. Testing can also include other tests, such as Speech Reception Threshold, Speech Recognition, Tinnitus Testing, among others. Hearing tests may be given in one or two parts, usually including an air-conduction test and/or a bone-conduction test. During air-conduction testing, earphones are worn by the subject and the sound travels through the air into the ear canal to stimulate the eardrum and then the auditory nerve. A tone at a particular frequency is presented to one ear, and its intensity is raised and lowered to find the lowest level (threshold) at which the person consistently responds (Verified Hearing Level). The person taking the test is instructed to give some type of response such as raising a finger or hand, pressing a button, pointing to the ear where the sound was received, or saying “yes” to indicate that the sound was heard. The subject's responses are recorded (e.g., manually or automatically), and the test results are typically plotted on an audiogram to illustrate the subject's hearing profile. Other tests results can be recorded in formats different than an audiogram. Signals of different frequency may be consecutively presented to the same ear (e.g., commonly for at least six frequencies), and then the other ear can be tested in the same manner.

Audiometers are ordinarily calibrated, thus ensuring accurate and meaningful test results. For example, a calibration device is typically used to ensure that a pure tone stimulus emitted by an audiometer is within a desired tolerance relative to Reference Equivalent Sound Pressure Levels, such as those provided in the American and international standards for audiometers (e.g., ANSI S3.6-2010, ISO/DIS 389-8-2004). A number of different electroacoustic features of an audiometer can typically be calibrated, including sound pressure level and bone conduction force level (for bone-conduction testing).

Accordingly, such hearing tests can be used to assess and interpret a subject's hearing thresholds and diagnose any hearing difficulties exhibited by the test subject. Of course these outcomes presume the availability of an accurately calibrated audiometer and a skilled and experienced audiologist who can conduct the hearing test and interpret its results. However, a person may desire to test his or her own hearing for a variety of reasons. For example, a person may find it inconvenient or expensive to schedule an appointment with a trained and licensed audiologist, or a person may not want to acknowledge hearing loss (by going to a doctor) and may just be curious. In addition, a layman would in most cases not want to purchase a professionally calibrated audiometer, which can be challenging to operate and cost hundreds or thousands of dollars.

Self-administered hearing tests have been developed to address these types of situations. Unfortunately, current self-administered hearing tests exhibit one or more drawbacks. Some self-administered air-conduction hearing tests are incorporated into an audio compact disc (CD) or computer software that produces a series of tones. However, such self-administered hearing tests do not automatically produce calibrated pure tones and thus can only provide an estimated measurement of threshold levels. In addition, test users may employ a variety of headphones, each of which may produce different sound pressure levels for the same audio signals generated and output by the test.

For accurate measurements, a test user must often purchase a separate calibration device (e.g., a coupler and sound level meter) and then manually calibrate the output of the software program or audio CD. Aside from the disadvantage of the added cost, calibrating the tonal output can be difficult, especially for a layman who is not a trained audiologist. Furthermore, while some self-administered hearing tests attempt to measure and display threshold levels, the meaning and implications of such results can remain unclear to a test user unfamiliar with standard hearing profiles.

Accordingly, there is a need for further improvements in self-administered hearing tests, such as, but not limited to, providing a kit, system and method for providing a self calibrating test.

### SUMMARY OF THE INVENTION

An object of the invention is to provide a self administered hearing test which is self calibrating.

Another object of the invention is to provide a test sequence which gathers and processes answers to subjective and clinical questions in addition to the results of the tone test.

Another object of the invention is to provide a kit, system and method which eliminate delays when performing the tone testing.

Another object of the invention is to provide a kit, system and method which allows the user to experience (or witness) corrected hearing based on the results of the testing.

Another object of the invention is to provide a kit, system and method which provides visual results and recommendations based on the results of the testing.

An embodiment is directed to a hearing test kit which includes a controlling earpiece having a speaker that generates stimuli and a microphone which detects ambient noise. The stimuli generated by the speaker compensates for the ambient noise detected by the microphone.

An embodiment is directed to an earpiece for use in conducting a hearing test. The earpiece includes a speaker which generates stimuli and a microphone which detects ambient noise. The stimuli generated by the speaker compensates for the ambient noise detected by the microphone.

An embodiment is directed to a method of conducting a hearing test. The method including: detecting ambient noise using a microphone housed in an earpiece; analyzing the ambient noise; and generating stimuli which have been adjusted to compensate for the ambient noise through a speaker housed in the earpiece.

The method may also detect ambient noise to establish a hearing level of 0 dB+/−5%.

The method may also include detecting the ambient noise at the beginning of the hearing test, or alternatively, detecting the ambient noise prior to the generation of each stimuli.

The method may also include generating the stimuli over a frequency range of between about 125 Hz and about 250 Hz, such as, for example, between about 250 Hz and about 8 kHz at sound pressure levels calibrated between about 0 dB to about 120 dB.

An embodiment is directed to a method of conducting a hearing test. The method including: detecting ambient noise; analyzing the ambient noise; and generating stimuli which have been adjusted to compensate for the ambient noise through a speaker housed in an controlling, active earpiece.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a perspective view of a hearing test kit according to an illustrative embodiment of the invention.

FIG. 2 is an exploded perspective view of a controlling, active ear piece of the headphones of the test kit shown in FIG. 1.

FIG. 3 is a cross-sectional view of a controlled, active ear piece.

FIG. 4 is a front perspective view of the controlling, active ear piece of the headphones of the test kit shown in FIG. 1.

FIG. 5 is a graph displaying representative test procedures for a Pure Tone hearing test according to an illustrative embodiment of the invention.

FIG. 6 is a graph displaying representative test results of a hearing test according to an illustrative embodiment of the invention.

### DETAILED DESCRIPTION OF THE INVENTION

The description of illustrative embodiments according to the principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivatives thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

Moreover, the detailed description is exemplary in nature and is not intended to limit the scope, applicability, or configuration of the invention in any way. Rather, the following description provides some practical illustrations for implementing illustrative embodiments of the present invention. Examples of constructions, materials, dimensions, and manufacturing processes are provided for selected elements, and all other elements employ that which is known to those of ordinary skill in the field of the invention. Those skilled in the art will recognize that many of the noted examples have a variety of suitable alternatives.

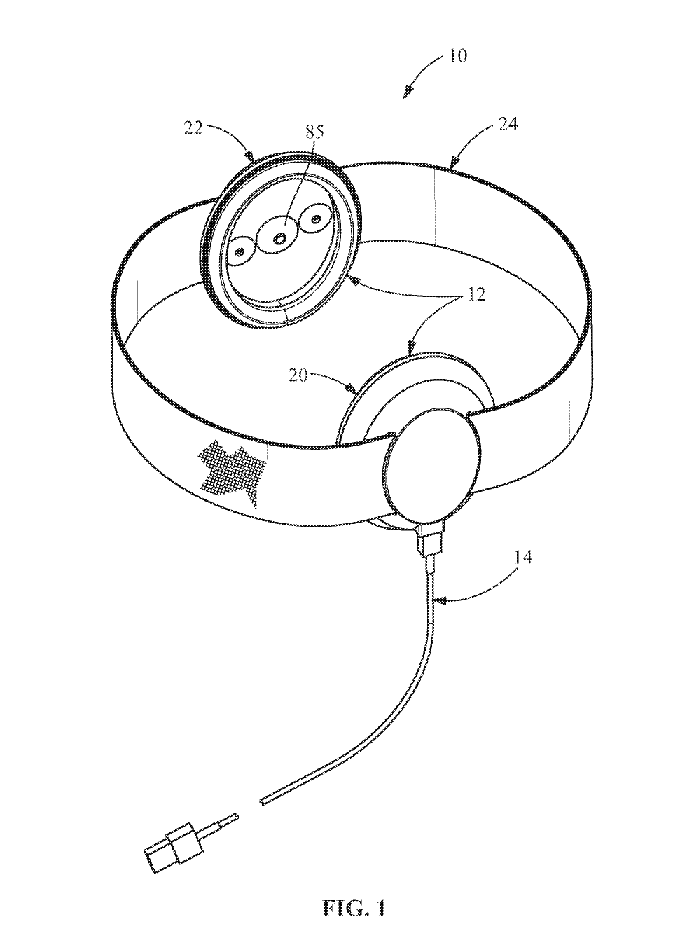

FIG. 1 shows an illustrative hearing test kit 10 according to an embodiment of the invention. Embodiments of the invention provide useful and convenient hearing test kits that allow a person to self-administer a hearing test using the kit and a computer or device which communicates with a computing device, such as, but not limited to, a server, a computer, a tablet, a smart phone, or other such device. Self-administered hearing tests can be conducted at essentially any reasonably quiet location with a personal computer. Thus, the hearing test kit 10 is useful in a variety of settings, including, but not limited to, a person's home.

The hearing test kit 10 of FIG. 1 includes a number of components that when combined with a computing device form a hearing test system that conducts a calibrated hearing test without the need for manual calibration. Thus, the hearing test kit 10 provides a distinct advantage over currently available hearing test kits in that the assembled test system generates calibrated pure stimuli such as, but not limited to, tones, spoken words, sounds, or other audible noises without the need to manually calibrate the hearing test system after set up. Accordingly, embodiments of the invention provide more accurate and reliable hearing test results than uncalibrated home hearing tests, and provide a calibrated sound output in relation to the ambient noise in the earpiece without the need for external calibrators and the expertise needed to calibrate the sound output of the headphones. Embodiments of the invention also allow the kit and the components to be mobile.

As shown in FIG. 1, the hearing test kit 10 includes headphones 12, straps 24 and a cable 14 which connects the headphones 12 to the computer. In the illustrative embodiment shown, the cable 14 is a USB cable, allowing information to be transferred to and from the headphones 12 with little or no delay or degradation of the signal. However, other types of cable can be used. Additionally, wireless configurations are envisioned, including, but not limited to Bluetooth, near field communication. In the embodiment shown, the kit 10 includes a web address and a password which allows the user to access, via the internet, instructions and a testing and evaluation program which guides a user through the self-administered hearing test. When plugging in the USB cable, or initiating the hearing test, the website is automatically addressed from firmware installed in the electronics requiring no additional user input. Alternatively, software may be provided. The software, when installed on the computer, guides the user through the self-administered hearing test, thereby eliminating the need for the internet connection.

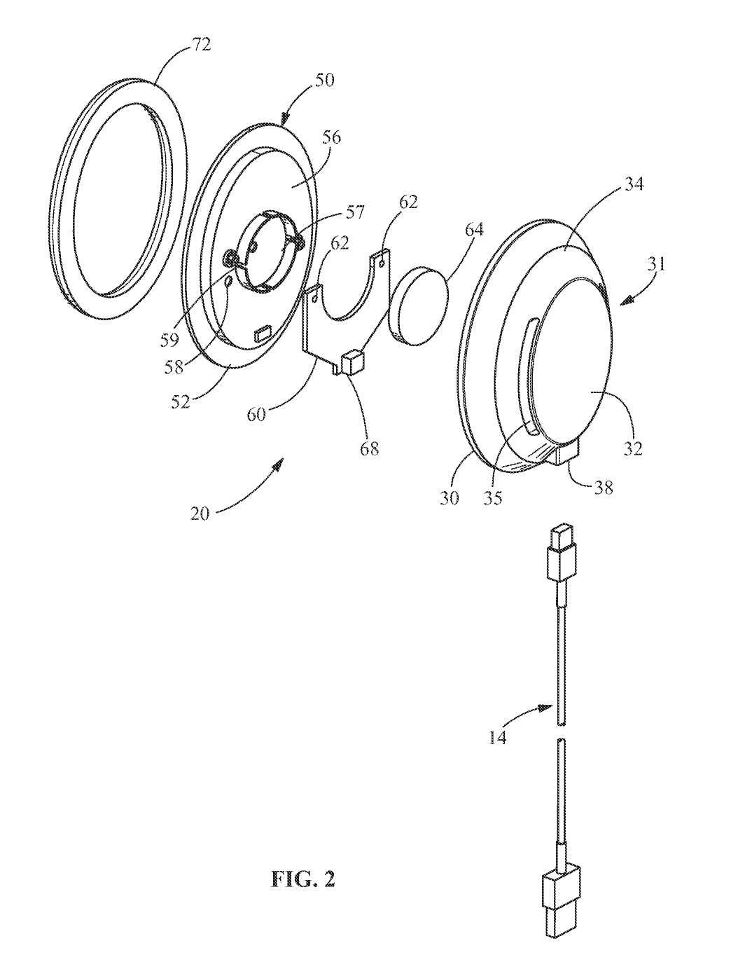

Referring to FIGS. 2 through 4, the headphones 12 have a controlling, active earpiece 20 and a controlled, active earpiece 22. Alternatively, earpiece 22 may be passive or inoperative.

An adjustable strap or arcuate member 24 (FIG. 1) extends between the earpieces 20, 22. The member 24 is adjustable to allow the member to conform to the size of the user's head, thereby allowing the earpieces 20, 22 to be snugly received against the user's ears. In illustrative embodiments, the ear pieces may be held in place with a force of 1ON. In the illustrative embodiment shown, the member 24 is an adjustable, stretchable strap which allows the user to properly secure the earpieces in position.

In the illustrative embodiment shown, the circumaural earpiece 20 has a housing or a cover 31 with a first surface 30 and a second surface 32. A sidewall 34 extends between the first surface 30 and the second surface 32. The cover 31 has a generally oval shape, with the first surface 30 being dimensioned to fit over the ear of the user. A cavity 36 extends from the first surface 30 toward the second surface 32. The cavity 36 has a general oval shape and is dimensioned to receive a retaining member 50 and a substrate or circuit board 60, as will be more fully described below. The sidewall 34 has a connector receiving opening 38 which extends therethrough. In the embodiment shown, strap receiving openings 35 extend through the sidewall 34 proximate the second surface 32. The strap receiving openings 35 cooperate with the strap 24 as shown in FIG. 1. The cover 31 may be made of various materials, including, but not limited to Acrylonytrile Butadiene Sytrene (ABS).

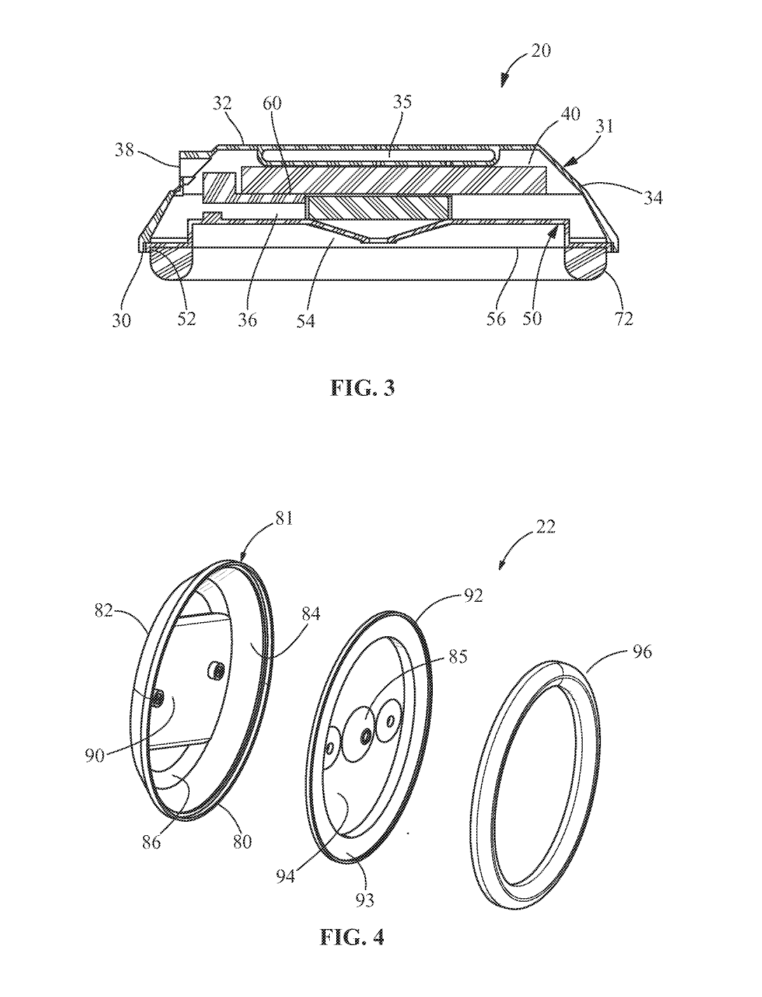

As shown in FIG. 3, sound dampening 40 may be positioned in the cover 31. The sound dampening 40 may be air or other material which have sound absorbing characteristics. The sound dampening 40 provides sound dampening between the outside environment and the ear of the user when the earpiece 20 is properly positioned on the ear of the user. The sound dampening 40 may be integrally molded with the cover 31 or may be a separate piece which is inserted into the cavity 36 and adhered to the second surface 32, the sidewall 34 or other portions of the earpiece 20 using conventional methods, such as, but not limited to adhesives. The sound dampening 40 may be made of various materials, including, but not limited to a fine celled, irradiation cross linked foam, such as, but not limited to Volara.

As best shown in FIGS. 2 and 3, the retaining member 50 is provided proximate the first surface 30. The retaining member 50 has a generally oval configuration and has similar dimensions to the first surface 30. The retaining member 50 has a padding receiving shoulder 52 which extends proximate the circumference or perimeter of the retaining member 50. An ear-receiving recess or cavity 54 extends from the shoulder 52 toward the second surface 32. A bottom wall 56 of the ear-receiving cavity 54 has speaker openings 57 and a microphone opening 58 which extends therethrough. In some illustrative embodiments, the speaker openings 57 have a conical configuration to direct the test tones directly to the ear canal. In addition, the shape of the openings 57 can help to reduce the impact of ambient noise. Similarly, microphone opening 58 may also have a conical shape. However, various shapes of the openings 57, 58 can be used without departing from the scope of the invention.

Mounting posts 59 extend from the bottom wall 56 in a direction opposed from the cavity 54. The retaining member 50 is inserted into the cavity 36 and adhered to the first surface 30, the sidewall 34 or other portions of the earpiece 20 using conventional methods, such as, but not limited to self-tapping screws for plastic or adhesives. The retaining member 50 may be made of various materials, including, but not limited to ABS.

The substrate, such as, but not limited to, a printed circuit board 60 is positioned between the bottom wall 56 of the retaining member 50 and the sound dampening 40. Openings 62 are provided on the circuit board 60 to cooperate with the mounting posts 59 to maintain the circuit board 60 is position relative to the retaining member 50 and the earpiece 20. The openings 62 are dimensioned to provide an interference or frictional engagement with the mounting posts 59, thereby maintaining the circuit board 60 in position. Alternatively, the mounting posts 59 may be deformed after the circuit board 60 is properly positioned. Other methods of maintaining the circuit board 60 is position relative to the retaining member 50 may be used without departing from the scope of the invention.

The circuit board 60 cooperates with a speaker 64 and a microphone 66 which are integral therewith or connected thereto. The speaker 64 and microphone 66 are mounted using conventional methods, such as, but not limited to, surface mounting. Solid state memory, such as, but not limited to, flash memory is also provided. The flash memory stores the start-up program used to connect the computer to the internet. In various embodiments, the flash memory may house programs to facilitate the calibration of the earpiece 20. Additionally, sound files may be housed in the flash memory and cooperate with the speaker 64 to generate the stimuli required for the hearing test. Alternatively, test files may be downloaded from the internet allowing the file to be changed or updated (language change, etc.) Alternatively, the substrate or circuit board may include a sound card. Such devices are known in the art. Leads 68 of the circuit board 60 extend to an edge of the circuit board 60 to form a connector receiving opening 38 which cooperates with a mating connector of the cable 14. Alternatively, a connector may be mounted to the circuit board 60 using known methods. In addition, the cable 14 may be directly soldered onto the circuit board 60.

A padded or comfort member 72 is provided and is positioned proximate the padding receiving shoulder 52 of the retaining member 50. The padded member 72 is provided to cushion the earpiece 20 from the user's head. In addition, the padded member 72 provides spacing to facilitate the proper positioning of the speaker 64 and microphone 66 relative to the user's ear. The padded member 72 also provides sound dampening when the padded member 72 is properly positioned on the user's head. The padded member 72 is positioned on the shoulder 52 and adhered to the shoulder 52 using conventional methods, such as, but not limited to adhesives. The padded member 72 may be made of various materials, including, but not limited to Volara.

As previously stated, the hearing test kit 10 includes circumaural earpieces 20, 22 which are positioned over the user's ears. The earpiece 20, as described above, has the circuit board 60 positioned therein and generates the stimuli required for the hearing test. In contrast, the earpiece 22 has no circuit board, but will have a speaker for stimuli generation. Alternatively, the earpiece 22 may have no speaker.

Earpiece 22 includes a housing or a cover 81 with a first surface 80 and a second surface 82. A sidewall 84 extends between the first surface 80 and the second surface 82. The cover 81 has a generally oval shape, with the first surface 80 being dimensioned to fit over the ear of the user. A cavity 86 extends from the first surface 80 toward the second surface 82. The cavity 86 has a general oval shape and is dimensioned to receive a retaining member 92. In the embodiment shown, strap receiving openings (not shown) extend through the sidewall 84 proximate the second surface 82. The strap receiving openings cooperate with the strap 24 as shown in FIG. 1. The cover 81 may be made of various materials, including, but not limited to ABS.

In the exemplary embodiment shown, a speaker 85 is positioned in earpiece 22. The speaker is in communication with and is controlled by circuit board 60 of earpiece 20. The speaker 85 is mounted in the earpiece using conventional methods. The speaker 85 may be used for sound masking or for delivering stimulus if a particular tests requires both ears be tested simultaneously (binaural stimulation). In the illustrative embodiment shown, the speaker drive is controlled by a 12 bit digital to analog converter and the volume is controlled by a microcontroller based system with a 10 bit analog to digital converter.

Sound dampening 90 may positioned in the cavity 86 proximate the second surface 82 of the cover 81. The sound dampening 90 may be air or other material which have sound absorbing characteristics. The sound dampening 90 provides sound dampening between the outside environment and the ear of the user when the circumaural earpiece 22 is properly positioned on the ear of the user. The sound dampening 90 may be integrally molded with the cover 81 or may be a separate piece which is inserted into the cavity 86 and adhered to the second surface 82, the sidewall 84 or other portions of the earpiece 22 using conventional methods, such as, but not limited to adhesives. The sound dampening 90 may be made of various materials, including, but not limited to Volara.

The retaining member 92 is provided proximate the first surface 80. The retaining member 92 has a generally oval configuration and has similar dimensions to the first surface 80. The retaining member 92 has a padding receiving shoulder 93 which extends proximate the circumference or perimeter of the retaining member 92. An ear-receiving recess or cavity 94 extends from the shoulder 93 toward the sound dampening 90 and the second surface 82. The retaining member 92 may be integrally molded with the cover 81 or may be a separate piece which is inserted into the cavity 86 and adhered to the first surface 80, the sidewall 84 or other portions of the earpiece 22 using conventional methods, such as, but not limited to adhesives. The retaining member 92 may be made of various materials, including, but not limited to ABS.

A padded or comfort member 96 is provided and is positioned proximate the padding receiving shoulder 93 of the retaining member 92. The padded member 96 is provided to cushion the earpiece 22 from the user's head. The padded member 96 also provides sound dampening when the padded member 96 is properly positioned on the user's head. The padded member 96 is positioned on the shoulder 93 and adhered to the shoulder 93 using conventional methods, such as, but not limited to adhesives. The padded member 96 may be made of various materials, including, but not limited to Volara.

When conducting a self-administered hearing test, the user connects a first end of the cable 14 to the circuit board 60 of the earpiece 20 through opening 38. The second end of the cable 14 is connected to the computer which is connected to the internet. As this occurs, the start-up program housed on the circuit board 60 is initiated and information is sent from the circuit board 60 though the cable 14 to the computer. The sent information causes the computer to connect via the internet to a designated web site or server. Upon connection to the designated web site, the software housed on the server sends instructions to the computer. The user views the instructions and begins the hearing test process. In order to perform the hearing test properly, it is beneficial to have the test space as quiet as possible, thereby minimizing the background (ambient) noise.

The user then places the circumaural earpiece 20 over the right ear and the circumaural earpiece 22 over the left ear. In one illustrative embodiment, the controlling, active earpiece 22 is red and the controlled earpiece is blue, per audiology tradition to distinguish them. Note that while the illustrative procedure is initiated in the right ear, the procedure may be initiated in the left ear without departing from the scope of the invention. The adjustable strap or member 24 is then tightened to allow the earpieces to be held snugly (10N) against the head of the user, capturing the user's ear in the ear-receiving cavities 52, 94. In this position, the padded members 72, 96 are slightly compressed against the user's head, thereby providing a seal which helps to prevent the ambient background noise present in the test space from entering the ear-receiving cavities 54, 94, thereby facilitating the sound dampening of the earpieces 20, 22 and preventing the contamination or degradation of the test results.

With the circumaural earpieces 20, 22 properly secured to the head of the user, the hearing test is initiated. The hearing test may be, but is not limited to one of the following tests; pure tone, tinnitus, speech reception threshold, speech recognition, emotive (as will be more fully described), speech in noise, acceptable noise level and/or any other type of air conduction hearing tests. Once the earpieces 20, 22 are properly secured, a sweep ambient noise test (using test frequencies from 250 Hz 20 kHz, but typically 500 Hz, 1 kHz, 2 kHz, 4 kHz, 8 kHz) is done to determine the ambient noise level. The ambient noise test is measuring the ambient noise within the earphone 20. In most cases, as the earphone 20 contains sound dampening, the ambient noise within the earpiece will be significantly less than room ambient noise level.

In one embodiment, if the ambient noise level is <40 dB the test is allowed to proceed. However, If the environment ambient noise level is not <40 dB, the test will not start. If ambient noise level is >40 dB the user is informed the environment is not suitable and the user is instructed to move locations or to shut off various devices that might be making the unwanted noise (by frequency). Another sweep ambient noise test is done to determine the ambient noise level. This is continued until the proper testing conditions are achieved. Additionally, a quick tone test may be conducted prior to the start of the actual hearing test to double check the earpieces are on the designated ear.

In one illustrative embodiment, the earpiece 20 can be calibrated prior to generating any stimuli. In this embodiment, the microphone 66 detects the background or ambient noise located in the ear-receiving cavities 54 of the earpiece 20. The results are transmitted via the circuit board 60, the cable 14, the computer and the internet to the server. The results are analyzed by the software to determine the amount of correction needed to set the 0 dB Hearing Level and produce a calibrated output. The generated stimuli which are sent from the server to the earpiece 20 are adjusted to compensate for the ambient noise.

Alternatively, or in addition to the above, the earpiece 20 can be calibrated prior to generating each individual stimuli. In this embodiment, the microphone 66 detects the background or ambient noise located in the ear-receiving cavities 54 of the earpiece 20 at multiple times during the test procedure, just prior to generating an individual stimuli. The results are transmitted via the circuit board 60, the cable 14, the computer and the internet to the server. The results are analyzed by the software to determine the amount of correction needed to set the 0 dB Hearing Level and produce a calibrated output. Each generated stimuli which is sent from the server to the earpiece 20 is adjusted to compensate for the ambient noise present at the time the individual stimuli is generated.

Whether calibrated prior to generating any stimuli or calibrated prior to generating each stimuli, the automatic noise cancellation described herein filters out the ambient noise. Regardless of the method, the ambient noise is measured such that a hearing level of 0 dB can be established. Such hearing level may have variance of, for example, +/−5%.

Consequently, the emitted stimuli are calibrated to predetermined sound pressure levels without any action on the part of the person administering and taking the hearing test. The components cooperate together to achieve the desired calibration without a need for any manual adjustments by the user. The predetermined sound pressure levels can range from 0 dB SPL to 120 dB SPL in prescribed dB increments. Currently the Pure Tone testing is done at 5 dB levels, but may also be done in 1 dB or 3 dB as well. In some cases the predetermined sound pressure levels are preferably a series of increasing sound pressure levels for each frequency measured relative to a reference equivalent Sound Pressure Level (SPL) for the particular frequency (for example between about 0 dB SPL to about 120 dB SPL, between about 0 dB SPL to about 85 dB SPL, between about 0 dB SPL to about 60 dB SPL, or any combination or subcombination thereof).

If the measured ambient noise is equal to or below a determined amount, such as for example 40 dB the hearing test may proceed, as previously described. The testing parameters allow for the test to proceed unencumbered provided that the ambient noise is at or below the presentation level+/−5% at the given test frequency. If the ambient noise exceeds the test parameters defined by the software a warning is provided to the user to lessen the ambient noise until the requirement is met, e.g. turn off appliances, etc. Sampling rate is determined to ensure fidelity is adhered to during the test.

The hearing test software guides a test subject through a hearing test. In general, the software comprises executable instructions that cause the computer (i.e., the computer processor) and earpiece 20 (i.e., the circuit board 60) to perform functions associated with the test. During a typical illustrative self-administered hearing test, the server will, among other things, instruct the computer to display a series of questions and will instruct the circuit board 60 by means of the speaker 64 to generate a series of stimuli that are audible to the user or test subject.

During the test, a series of questions will be displayed for the user to answer. The questions may involve subjective questions and clinical questions. The subjective questions include question related to how the user responds and interacts in different situations. Answers to the subjective questions will indicate whether or not the user displays characteristics of someone with known hearing loss. The clinical questions include questions related to known medical conditions that may contribute to the hearing lose of the user and the answers may indicate that the user should seek medical evaluation or intervention. Additionally, some answers to the clinical questions would disqualify the user from the testing process.

The protocol for the generation of the series of stimuli that are audible to the user or test subject may vary depending upon the testing methodology used. For example, for a pure tone test sequence, a series of tones over a frequency range of between about 250 Hz and about 8 kHz, between about 500 Hz and about 8 kHz, above about 250 Hz, above about 500 Hz, below about 8 kHz, or any combination or subcombination are generated. In one embodiment, the series includes tones at these frequencies: 250 Hz, 500 Hz, 750 Hz, 1 kHz, 1.5 kHz, 2 kHz, 3 kHz, 4 kHz, 6 kHz, and 8 kHz. In other embodiments, other series of tones from 20 Hz to 20 kHz may be generated.

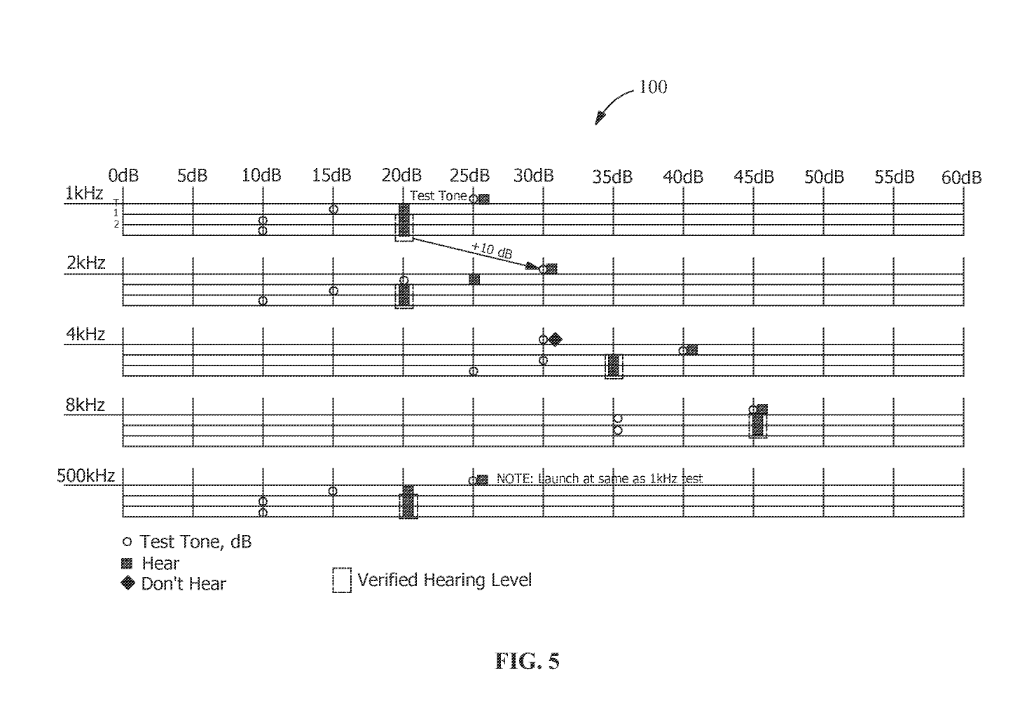

In one illustrative embodiment, tones are generated at the frequencies shown in graph 100 of FIG. 5, in accordance with the generally accepted and standardized Hughs and Westlake diagnostic methodology. The tones or stimuli may be launched with a nonlinear cadence to prevent counting and false positives. As is shown, the initial test tone generated at the 1 kHz is generated at 25 db. In this example, the user indicates that the tone is heard. In response, the next test tone is generated at 15 db (which is 10 db less that the last heard tone). The user does not hear the tone at 15 dB, so the tone is increased by 5 dB to 20 dB. At 20 dB, the user indicates that the tone is heard. In response, the next test tone is generated at 10 db (which is 10 db less than the last heard tone). The user does not hear the tone at 10 dB, so the tone is increased by 5 dB to 15 dB. The user does not hear the tone at 15 dB, so the tone is increased by 5 dB to 20 dB. At 20 dB, the user indicates that the tone is heard. As the user has heard the tone at 20 dB for two consecutive ascending tests, the hearing level for 1 kHz is verified at 20 dB. This process in repeated for the other frequencies shown. However, the initial test tone for each additional frequency is increase 10 dB from the verified level of the previous frequency. This is just one illustrative embodiment of a test procedure and is not meant to limit the scope of the invention. Other frequencies, volume and differentials can be used without departing from the scope of the invention.

While a particular protocol is described with reference to the illustrative embodiment, the self-administered hearing test can be any test known in the art and threshold levels can be measured/identified according to any procedure known in the art. Such tests include presenting a set of acoustic stimuli to the subject and the subject is asked to respond when he or she hears a stimulus. Each stimulus is typically an air-conducted stimulus. The stimuli are presented to the subject at different frequencies and intensities.

With the testing completed on the right ear, the program directs signals through the circuit board 60 to the speaker 85 in the earpiece 22 to test the left ear. As this occurs, the microphone 66 detects the background or ambient noise located in the ear-receiving cavity 54 of the earpiece 20 to determine the amount of correction needed to set the 0 dB Hearing Level and produce a calibrated output. As the ambient noise present in either earpiece 20, 22 is essentially the same, the detection of the ambient noise in earpiece 20 is sufficient for proper calibration. Alternatively, the earpiece 22 may have a microphone provided therein for detection of the ambient noise in the ear receiving cavity 94. If the earpiece 22 does not have a speaker, the earpiece 20 is placed over the left ear and the earpiece 22 is placed over the right ear and the testing is repeated for the left ear.

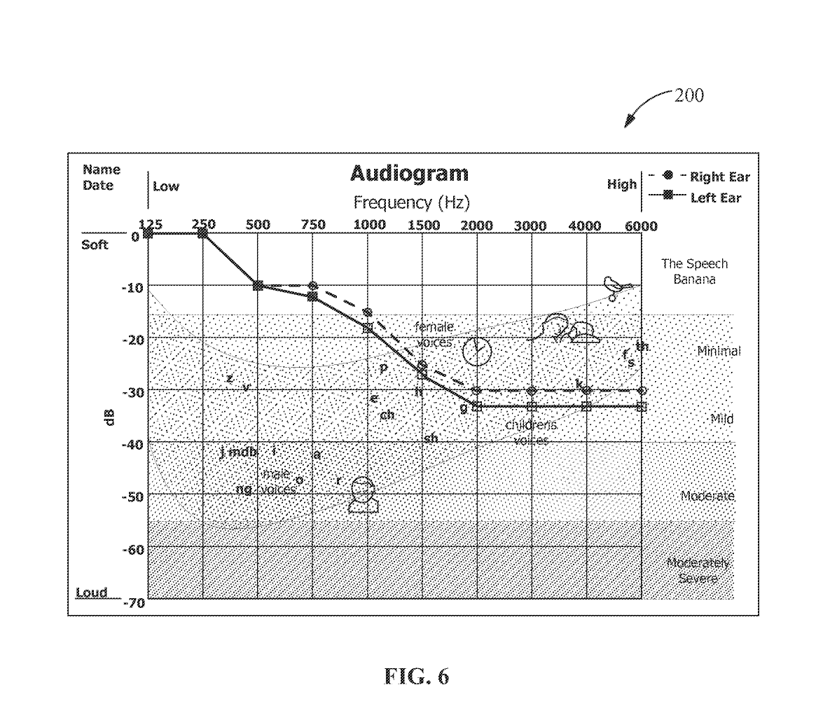

With the testing complete, the results of the questions and responses to the stimuli are analyzed. Interpretation of test results are analyzed through an expert system algorithm designed by an experienced audiologist through the computing device and communicated back to the user by means of the computer. As shown in display 200 of FIG. 6, the results may be communicated in graph form to allow the user to more easily understand any issues that they have with their hearing. Results may also be provided in different graphs or in other forms, such as, but not limited to, written or audible form. In addition to providing quantitative threshold data, the results also may convey qualitative hearing test result information. In some embodiments the report includes a qualitative interpretation of the identified user threshold values that explains to the user the nature and severity of the hearing loss (if any). The interpretive information can include any useful information corresponding to the identified user threshold levels. In some cases one or more standard interpretive statements may be identified based on the threshold level and then inserted into the report.

According to some embodiments, the interpretive information may include a classification for the user's hearing results and/or a statement of the likely communicative difficulties resulting from the identified hearing loss. For example, after determining the threshold levels for one or both ears, the hearing test software may then proceed to classify the identified levels based on a classification scheme. Several classification schemes are possible, and the invention is not limited to any particular classification scheme.

Further the hearing test software may in some cases provide recommendations to the test subject based on the identified threshold values. For example, the results may recommend that the user follow up the self-administered test with a clinical appointment, audiologic or medical, to determine the nature and severity of any hearing loss.

Additional steps may also be incorporated into the described method. In addition to the initiation, calibration, testing (which includes, but is not limited to, pure tone testing, tinnitus testing, speech reception threshold testing, speech recognition testing, speech in noise testing and acceptable noise level testing) and results/recommendation steps described above, other procedures and or testing may be performed, such as, but not limited to emotive testing/screening, experience procedures, best practices procedures, selection/fitting of the hearing aid, and purchasing of the hearing device, such as a hearing aid or PSAP (personal sound amplification product).

As stated above, the methodology may include aspects of best practices as determined by those versed in the practice of audiology. Best practices, as used in the audiology industry, relates to understanding subjective patient motivation, buying preference, expectations and perception of hearing ability. Questionnaires and tests extracted from, but not limited to industry tests such as: Characteristics of Amplification Tool (COATS), multiple environment listening utility (MELU), Client Oriented Scale of Improvement (COSI), TELEGRAM, and the Red Flag Test matrix, can be used independently, together, and often selectively based on previous tests and answers to aid in the identification of user lifestyle characteristics. Lifestyle characteristics and buyer preferences are key determinants in suitability of the product. These are usually distinct and classified as performance, cosmetic, simplicity, and price. The expert system incorporated with the software of the hearing kit will use the information obtained from these tests and make weighted recommendations for appropriate rehabilitation device or process, diagnostic testing and/or medical referrals.

The emotive hearing test is a hearing test where a series of actual sounds paired with actual pictures are delivered at normal levels to the patient. The patient will then increase or decrease the volume until they can hear the sound easily. The increase or decrease in the volume will be tracked, recorded and plotted to give a visual representation of the recorded responses compared to responses of users with no hearing impairment. The test sounds will be selected from events that are in frequency ranges and loudness ranges that are normally compromised with mild to moderate hearing loss. Such test sounds may be, but are not limited to: birds chirping (or baby chicks), young children talking, leaves rustling, clock ticking, water dripping, whispering, female voices, electric fan, cat meow, dog bark, elevator rising/falling warning bells, microwave beep, turn signal clicking, small waves crashing onto sand, breathing, babbling brook, gentle rain, wind through the trees, etc. Results will be reported in a format that shows results compared to normal hearing, In addition, the various sounds may be categorized according to low, mid range, and high frequency segments to allow the patient to better understand the issues.

As hearing loss is usually gradual, people with hearing loss in the mild to moderate range often believe they can hear properly and do not realize the extent of their hearing issue (contrary to what those around them experience). Other people close to the person with hearing loss are usually the first to notice the hearing loss before the actual person with hearing loss senses a change in their hearing acuity. The emotive hearing test will demonstrate what types of sounds the person with hearing loss is missing. In so doing, the emotive test may help convince the person with hearing loss to get the appropriate level of hearing correction. In other words, the emotive test will educate the test taker as to how their hearing compares to normal levels, thereby allowing them to decide if they need hearing correction. Alternatively, if the emotive test is used prior to conducting any other hearing tests, the emotive test can help the user to decide if they should pursue more formal testing as described above or with an audiology professional.

For all tests, the software includes logic to detect and prevent false positive acknowledgements during the test process. This may be achieved, but not limited to, introducing a non linear cadence to the test stimuli. By incorporating such false positive logic, more accurate and meaningful results can be obtained.

Some or all of the tests described above may be conducted more than once over multiple times or day to confirm the results of the test and/or to assess the effectiveness of any subsequent hearing device used.

While the invention has been described with reference to a preferred embodiment, it will be understood by those skilled in the art that various changes may be made and equivalents may be substituted for elements thereof without departing from the spirit and scope of the invention as defined in the accompanying claims. In particular, it will be clear to those skilled in the art that the present invention may be embodied in other specific forms, structures, arrangements, proportions, sizes, and with other elements, materials, and components, without departing from the spirit or essential characteristics thereof. One skilled in the art will appreciate that the invention may be used with many modifications of structure, arrangement, proportions, sizes, materials, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims, and not limited to the foregoing description or embodiments.

1. A hearing test kit comprising:
a controlling earpiece having a speaker which generates stimuli and a microphone which detects ambient noise;
wherein the stimuli generated by the speaker compensates for the ambient noise detected by the microphone.

2. The hearing test kit as recited in claim 1, wherein the controlling earpiece is a circumaural earpiece which has a substrate which receives input from the microphone and provides output to the speaker.

3. The hearing test kit as recited in claim 2, wherein the substrate communicates with software, the software analyzes the input from the microphone and calibrates the output to the speakers to compensate for the ambient noise.

4. The hearing test kit as recited in claim 3, wherein the substrate is a circuit board.

5. The hearing test kit as recited in claim 2, comprising a cable for connecting the controlling earpiece to a device which is in communication with a server which runs the software.

6. The hearing test kit as recited in claim 2, wherein the controlling earpiece is wireless in communication with a server which runs the software.

7. The hearing test kit as recited in claim 1, wherein the controlling earpiece includes sound dampening.

8. The hearing test kit as recited in claim 1, wherein the controlling earpiece includes padding which provides cushioning.

9. The hearing test kit as recited in claim 1, comprising a controlled earpiece, wherein the controlled earpiece is positioned over a non-test ear of a user.

10. The hearing test kit as recited in claim 1, wherein an adjustable strap is provided between the controlling earpiece and the controlled earpiece, where in the controlling earpiece and the controlled earpiece apply pressure against a head of a user by adjusting the adjustable strap.

11. An earpiece for use in conducting a hearing test, the earpiece comprising:
a speaker which generates stimuli: and
a microphone which detects ambient noise;
wherein the stimuli generated by the speaker compensates for the ambient noise detected by the microphone.

12. The earpiece as recited in claim 11, wherein the earpiece is a circumaural earpiece comprising a substrate which receives input from the microphone and provides output to the speaker.

13. The earpiece as recited in claim 12, wherein the substrate is a circuit board.

14. The earpiece as recited in claim 11, comprising sound dampening.

15. The earpiece as recited in claim 11, comprising a retaining member having a ear-receiving cavity.

16. The earpiece as recited in claim 15, comprising a padding member extending from the retaining member, the padding member provides cushioning.

17. A method of conducting a hearing test, the method comprising:
detecting ambient noise using a microphone housed in an earpiece;
analyzing the ambient noise;
generating stimuli which have been adjusted to compensate for the ambient noise through a speaker housed in the earpiece.

18. The method as recited in claim 17, The stimuli generated are adjusted to set a 0 dB hearing level and produce a calibrated output.

19. The method as recited in claim 17, wherein the ambient noise is detected at the beginning of the hearing test.

20. The method as recited in claim 17, wherein the ambient noise is detected prior to the generation of each stimuli.

21. The method as recited in claim 17, wherein the hearing test is a self-administered hearing test.

22. The method as recited in claim 17, wherein the stimuli are generated over a frequency range of between about 20 Hz and about 8 kHz.

23. The method as recited in claim 17, wherein stimuli for particular frequencies are sound pressure levels for particular stimuli frequencies calibrated between about 0 dB to about 120 dB.

24. A method of conducting a hearing test, the method comprising:
detecting ambient noise;
analyzing the ambient noise;
generating stimuli which have been adjusted to compensate for the ambient noise through a speaker housed in a controlling, active earpiece.

25. The method as recited in claim 24, wherein the hearing test is any type of air conduction hearing test.

26. The method as recited in claim 25, wherein the hearing test includes tests selected from the group consisting of pure tone, tinnitus, speech reception threshold, speech recognition, emotive, speech in noise, and/or acceptable noise level.

27. The method as recited in claim 24, wherein the hearing test includes questions related to understanding subjective patient motivation, buying preference, expectations and perception of hearing ability to aid in the identification of user lifestyle characteristics.

28. The method as recited in claim 27, wherein hearing test includes tests selected from the group consisting of characteristics of amplification tool, multiple environment listening utility, client oriented scale of improvement, TELEGRAM, and/or red flag test matrix, can be used independently, together, and often selectively based on previous tests and answers to aid in the identification of user lifestyle characteristics.

29. The method as recited in claim 28, wherein the hearing test is conducted more than once over multiple times.

30. The method as recited in claim 24, wherein results of the hearing test are transmitted to software which uses the information to make weighted recommendations for appropriate rehabilitation device or process, diagnostic testing and/or medical referrals.

31. The method as recited in claim 24, comprising;
delivering a series of actual sounds paired with actual pictures at normal sound levels to a user;
tracking responses from the user regarding the amount the user increases or decreases the volume;
plotting the responses of the compared to responses of users with no hearing impairment to provide the user with a visual representation.

32. The method as recited in claim 30, wherein the sounds are selected from events that are in frequency ranges and loudness ranges that are normally compromised with mild to moderate hearing loss.

33. The method as recited in claim 24, wherein logic is provided in the software to detect and prevent false positive acknowledgements during the test process.

34. The method as recited in claim 32, wherein the logic is a non linear cadence to the stimuli.
